(19) United States
(12) Patent Application Publication
(10) Pub. No.: US 2019/0217748 A1
(43) Pub. Date: Jul. 18, 2019

(54) MOTOR VEHICLE HAVING A TRANSFORMABLE REAR SEAT

(71) Applicant: Ford Global Technologies, LLC, Dearborn, MI (US)

(72) Inventor: Filip Krnja, London (GB)

(73) Assignee: Ford Global Technologies, LLC, Dearborn, MI (US)

(21) Appl. No.: 16/241,084

(22) Filed: Jan. 7, 2019

(30) Foreign Application Priority Data
Jan. 18, 2018 (GB) 1800810.2

(51) Int. Cl. B60N 2/14; B60N 2/20; B60N 2/06

(52) U.S. Cl. CPC B60N 2/143; B60N 2/065; B60N 2/206; B60N 2/203

(57) ABSTRACT

A motor vehicle is disclosed having at least one transformable rear seat that can be transformed from a forward facing state to a rear facing state by rotation the transformable rear seat about a horizontal transverse pivot axis located at a rear end of the transformable rear seat.

### FIELD OF THE INVENTION

The present invention generally relates to motor vehicles, and more particularly relates to a vehicle rear seat that can be transformed from a forward facing state to a rearward facing state.

### BACKGROUND OF THE INVENTION

There are situations such as “tailgate picnics” where it is desirable to have additional seating. Such additional seating is normally provided by the use of additional seating that is carried in the motor vehicle.

It is generally known from U.S. Patent Application Publication No. 2009/0179450 to provide a rear seat for a motor vehicle that can be re-configured from a forward facing position to a rear facing position by moving a backrest of the seat. It may be a disadvantage of such an arrangement that, when in the rear facing position, the seat base lies within the passenger compartment of the vehicle and so the legs of a passenger seated on the seat are poorly supported and are likely to impinge against the rear body work of the motor vehicle.

It would be desirable to provide a rear seat for a motor vehicle that can be transformed in a simple and cost effective manner from a forward facing state to a rear facing state.

### SUMMARY OF THE INVENTION

According to a first aspect of the invention, there is provided motor vehicle having a passenger compartment, a number of rows of seats mounted in the passenger compartment and a tailgate to provide access to a rear end of the passenger compartment, at least one seat forming a rear row of seats being a transformable rear seat pivotally connected at a rear end to a floor of the motor vehicle for rotation about a horizontal pivot axis arranged transversely with respect to a longitudinal axis of the motor vehicle, the transformable rear seat comprising a seat base and a seat backrest connected at one end to the rear end of the seat base, the transformable rear seat being reversibly transformable between a forward facing state and a rear facing state in which a rearmost end of the seat backrest projects beyond a rear end of the motor vehicle and the tailgate is in an open position wherein the transformable rear seat is reversibly transformable between the forward facing state and the rear facing state by rotating the transformable rear seat about the horizontal transverse pivot axis wherein the seat base is slidingly supported on the floor of the motor vehicle and the transformation of the transformable rear seat from the forward facing state to the rear facing state further comprises sliding the seat base rearwardly so as to move the horizontal transverse pivot axis closer to the rear end of the motor vehicle.

In the normal forward facing state, the transformable rear seat may face towards a front end of the motor vehicle, the seat base may be substantially horizontally arranged and the seat backrest may extend upwardly away from the seat base and the seat base may extend forwardly away from the seat backrest and, in the rear facing state, the transformable rear seat may face towards a rear end of the motor vehicle, the seat backrest may be substantially horizontally arranged and may extend rearwardly from the seat base and the seat base may extend upwardly away from the seat backrest.

The rearmost end of the seat backrest may be formed by a headrest portion of the seat backrest.

Sliding the seat base rearwardly so as to move the horizontal transverse pivot axis closer to the rear end of the motor vehicle may increase the distance the rearmost end of the seat backrest projects beyond the rear end of the motor vehicle.

The seat base may include an extendable seat bolster portion and the seat bolster portion may be extended in the rear facing seat state to increase the height the seat base projects upwardly from the seat backrest.

The seat backrest may be connected at one end to the rear end of the seat base by a rake adjuster to permit the angular relationship between the seat base and the seat backrest to be adjusted.

The motor vehicle may have three rows of seats and the transformable rear seat may be a single seat forming part of the rearmost row of seats.

Alternatively, the motor vehicle may have three rows of seats and the transformable rear seat may be a bench seat forming the rearmost row of seats.

The transformable rear seat may be pivotally connected at near a rear end of the seat base to the floor of the motor vehicle for rotation about the horizontal transverse pivot axis.

The tailgate may be one of a top hinged tailgate and a side hinged tailgate.

By changing the orientation of one or more seats forming a rear row of seats of a motor vehicle having a tailgate it is possible to provide additional seating by utilizing the rear row of seats of the motor vehicle.

According to another aspect of the present invention, a vehicle is provided. The vehicle includes a passenger compartment, a floor, a rear end, a tailgate at the rear end, and a transformable seat comprising a seat base and a seat backrest and pivotally connected to the floor for rotation about a horizontal pivot axis arranged transversely with respect to a longitudinal axis of the vehicle to rotate.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a cutaway right hand side view of a motor vehicle according to one embodiment showing a transformable rear seat in a forward facing state;

FIG. 2 is a cutaway right hand side view of the motor vehicle shown in FIG. 1 showing the transformable rear seat in a rear facing state;

FIG. 3a is an enlarged diagrammatic side view of the transformable seat shown in FIG. 1 showing the transformable rear seat in the forward facing state;

FIG. 3b is an enlarged diagrammatic side view of the transformable seat shown in FIGS. 1 and 2 showing the transformable rear seat during transformation between the forward facing and rear facing states;

FIG. 3c is an enlarged diagrammatic side view of the transformable seat shown in FIG. 2 showing the transformable rear seat in the rear facing state;

FIG. 3d is an enlarged diagrammatic side view similar to the side view shown in FIG. 3c but instead showing the transformable seat in a rearwardly slid position with a seat bolster portion of a seat base in an extended position; and

FIG. 4 is a pictorial view of an alternative third row seating arrangement having two transformable rear seats constructed in accordance with one embodiment.

### DETAILED DESCRIPTION OF THE PREFERRED EMBODIMENTS

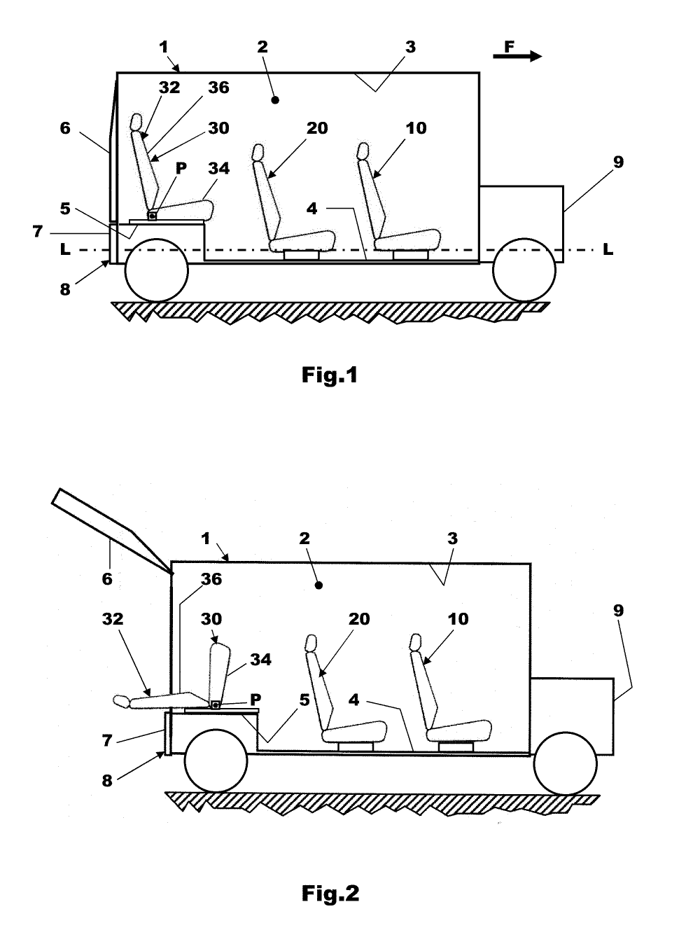

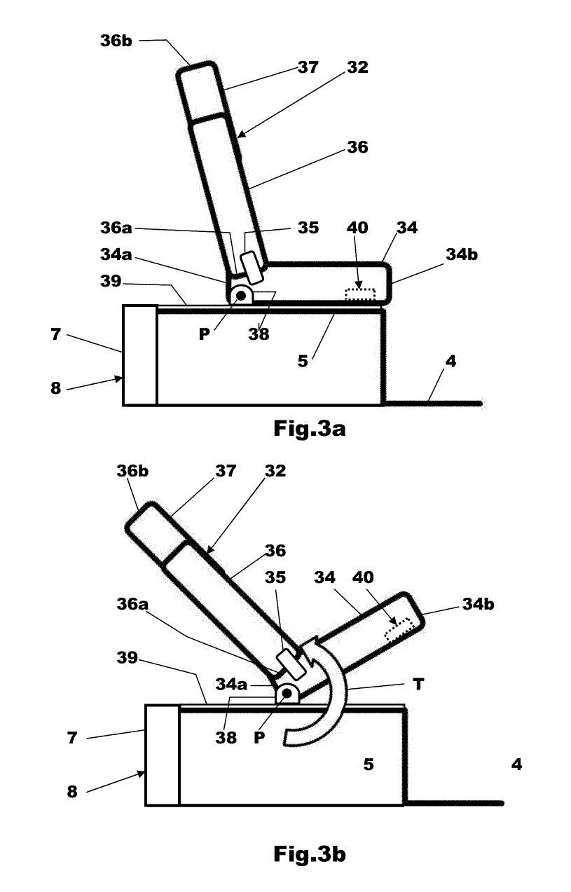

With particular reference to FIGS. 1 and 2 there is shown a motor vehicle 1 having a passenger compartment 2, in which is mounted three rows of seats 10, 20, 30 and a top hinged tailgate 6 to provide access to a rear end of the passenger compartment 2. The passenger compartment has a roof 3 and a floor 4. The floor 4 includes a raised rear floor 5.

The motor vehicle 1 has a rear end 7 formed by a rear bumper 8 and a front end 9. A longitudinal axis L-L of the motor vehicle 1 extends from the front end 9 of the motor vehicle 1 to the rear end 7 of the motor vehicle 1. When the motor vehicle 1 is moving in a forward direction it moves in the direction indicated by the arrow “F” on FIG. 1.

In the case of this example there is a first or front row of seats 10, a second or middle row of seats 20 and a rear or third row of seats 30. At least one seat forming the rear row of seats 30 is a transformable rear seat 32 and, in the case of this example, the rear row of seats 30 comprises a single transformable rear bench seat 32.

The transformable rear seat 32 is pivotally connected at a rear end to the rear floor 5 of the motor vehicle 1 for rotation about a substantially horizontal pivot axis “P” arranged transversely with respect to the longitudinal axis L-L of the motor vehicle 1. That is to say, when the motor vehicle 1 is viewed from above, the horizontal transverse pivot axis “P” is arranged at right angles to the longitudinal axis L-L of the motor vehicle 1.

The transformable rear seat comprises a seat base 32 and a seat backrest 36 connected at one end to a rear end of the seat base 34. The transformable rear seat 32 is reversibly transformable between a normal or forward facing state, as shown in FIG. 1, to a picnic or rear facing state by rotating the transformable rear seat 32 about the horizontal transverse pivot axis “P.”

It will be appreciated that the top hinged tailgate 6 must be opened to permit transforming of the transformable rear seat 32 from the forward facing state to the rear facing state. It will also be appreciated that while the vehicle is described and shown with reference to a top hinged tailgate it is also applicable to a vehicle having side hinged tailgate. It will be further appreciated that the whole transformable rear seat 32 is rotated as a single unit when transforming it between the forward and rear facing states. “Transforming” as meant herein means moving the rear seat 32 between its two seating states.

It will be appreciated that a latching mechanism (not shown in FIGS. 1 and 2) may be provided to hold the transformable rear seat in at least the forward facing state and preferably in both the forward facing state and the rear facing state.

In the forward facing state shown in FIG. 1, the transformable rear seat 32 faces towards the front end 9 of the motor vehicle 1, the seat base 34 is substantially horizontally arranged, the seat backrest 36 extends upwardly away from the seat base 34 and the seat base 32 extends forwardly away from the seat backrest 36 towards the front end 9 of the motor vehicle 1.

Whereas, in the rear facing state shown in FIG. 2, the transformable rear seat 32 faces towards the rear end 7 of the motor vehicle 1, the seat backrest 36 is substantially horizontally arranged and extends rearwardly from the seat base 34 and the seat base 34 extends upwardly away from the seat base.

In the rear facing state, a rearmost end of the seat backrest 36 projects beyond the rear end 7 of the motor vehicle 1 so as to provide a picnic seating position for one or more passengers of the motor vehicle 1. In the rear facing state an occupant of the transformable rear seat 32 can comfortably sit with their legs supported by the seat backrest 36 and extending out of the rear end of the passenger compartment 2 of the motor vehicle 1.

It will be appreciated that, when the top hinged tailgate 6 is in an open position and the transformable rear seat 32 is in the rear facing state, the tailgate 6 will provide some protection from rain or sun to an occupant of the transformable rear seat 32. This is one advantage of using such a transformable rear seat in a motor vehicle having a top hinged tailgate compared to a motor vehicle having a side hinged tailgate.

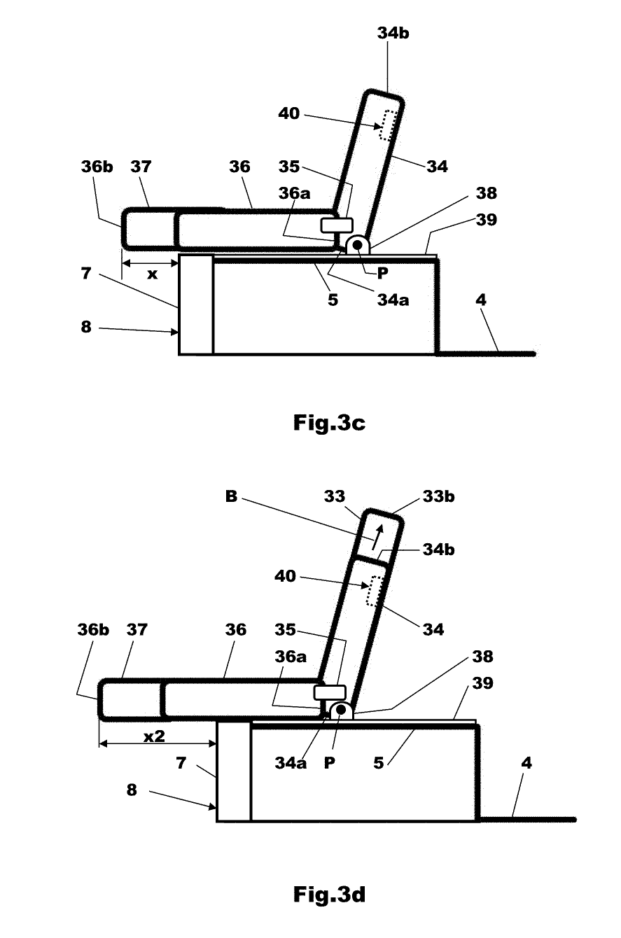

With particular reference to FIGS. 3a-3d the seat base 34 has a first end 34a and a second end 34b and in the forward facing state the second end 34b of the seat base 34 is located closer to the front end of the motor vehicle 1 than the first end 34a of the seat base 34. The seat backrest 36 has a first end 36a and a second end 36b and, in the forward facing state, the second end 36b of the seat backrest 34 is located closer to the roof 3 of the motor vehicle 1 than the first end 36a of the seat backrest 36. In the case of the example shown the second end 36b is formed by an end face of an integral head restraint 37. It will be appreciated that at all times the first end 36a of the seat backrest 36 remains adjacent to the first end 34a of the seat base 34.

As before, in the forward facing state, the transformable rear seat 32 faces towards the front end 9 of the motor vehicle 1, the seat base 34 is substantially horizontally arranged, the seat backrest 36 extends upwardly away from the seat base 34 and the seat base 32 extends forwardly away from the seat backrest 36 towards the front end 9 of the motor vehicle 1 and in the rear facing state, the transformable rear seat 32 faces towards the rear end 7 of the motor vehicle 1, the seat backrest 36 is substantially horizontally arranged and extends rearwardly from the seat base 34 and the seat base 34 extends upwardly away from the seat base 34.

The seat base 34 is, in the case of this example, slidingly supported at each end on the rear floor 5 of the motor vehicle 1 by a support bracket 38 that is slidingly engaged with a slide rail 39 fastened to an upper surface of the rear floor 5. The support bracket 38 pivotally supports a rear end of the seat base 34 for rotation about the horizontal transverse pivot axis “P.”

In the case of the examples shown in FIGS. 3a-3d the transformable rear seat 32 is pivotally connected at a rear end to the rear floor 5 of the motor vehicle 1 via the seat base 32 and the support bracket 38 but it will be appreciated that other arrangements for connecting the transformable rear seat 32 to the floor 5 could be used. It will also be appreciated that in other embodiments the support brackets 38 could be fastened directly to the rear floor 5 so that sliding of the transformable rear seat 32 is not possible.

The seat backrest 36 is pivotally connected near to the first end 36a end to the seat base 34 by a rake adjuster 35. The rake adjuster 35 permits the angular relationship between the seat backrest 36 and the seat base 34 to be adjusted. The rake adjuster 35 is fastened to the seat base 34 near to the first end 34a of the seat base 34 which, when the transformable rear seat 32 is in the forward facing state shown in FIG. 3a, is a rear end of the seat base 34.

A combined latching and support mechanism 40 (shown in dotted outline) is provided to prevent forward and rearward sliding of the transformable seat 32 and to prevent rotary motion of the transformable rear seat 32 from the forward facing state. When the combined latching and support mechanism 40 is released, rotation of the transformable rear seat 32 from the forward facing state to the rear facing state is possible and forward and rearward sliding of the transformable rear seat 32 is possible.

To transform the transformable rear seat 32 from the forward facing state to the rear facing state the combined latching and support mechanism 40 is unlatched and the transformable rear seat 32 can then be rotated in the direction indicated by the arrow “T” on FIG. 3b about the horizontal transverse pivot axis “P.” That is to say, the whole transformable rear seat 32 is rotated as a unit about the horizontal transverse pivot axis “P.”

FIG. 3c shows the orientation of the transformable rear seat 32 in the rear facing state following transformation from the forward facing state. In this example no latching mechanism is provided to hold the transformable rear seat 32 in this rear facing state, but it will be appreciated that a latching mechanism could be provided if so required. As shown in FIG. 3c, when in the rear facing state, a rearmost end formed by the second end 36b of the seat backrest 36 projects beyond the rear end 7 of the motor vehicle 1 by a distance ‘x.’ It will be appreciated that the rearmost end of the seat backrest 36 is in the case of this example formed by the end face of the headrest portion 37 of the seat backrest 36. As before, in this position an occupant of the transformable rear seat 32 can comfortably sit on the transformable rear seat 32 with the occupant's legs supported so as to extend out of the rear end of the passenger compartment 2 of the motor vehicle 1. It will be appreciated that the top hinged tailgate 6 must be in an open position when the transformable rear seat 32 is in the rear facing state and that when the tailgate 6 is in the open position it will provide some protection from rain or sun to an occupant of the transformable rear seat 32.

FIG. 3d shows two additional features that may be used in other embodiments shown on a single figure. The first of these features is the sliding as part of the transformation of the transformable rear seat 32 from the forward facing state to the rear facing state of the transformable rear seat 32 rearwardly so as to move the horizontal transverse pivot axis “P” closer to the rear end 7 of the motor vehicle 1. That is to say, the seat base 34 is slid in a rearward direction by allowing the support brackets 38 attached to the seat base 34 to slide along the slide rails 39. This is a useful feature if there is a large luggage compartment to the rear of the transformable rear seat 32 when it is in the forward facing state and the length of the seat backrest 36 would not be sufficient to permit the rearmost end 36b of the seat backrest 36 to project out from the rear end 7 of the motor vehicle 1. This is not the case with the example shown in FIG. 3d for which the effect is merely to increase the distance ‘×2’ the rearmost end formed by the second end 36b of the seat backrest 36 projects beyond the rear end 7 of the motor vehicle 1.

The second feature shown in FIG. 3d is the use of an extendable seat bolster 33 to increase the height the seat base 34 projects upwardly from the seat backrest 36 when the transformable rear seat 32 is in the rear facing position. Extendable seat bolsters are generally known from, for example, U.S. Pat. No. 9,566,888 and by extending the seat bolster 33 the effective length of the seat base 34 is increased and an end face 33b of the seat bolster 33 becomes effectively a top edge of the seat base 34. This is advantageous in that the length of a seat base is normally less than the length of a seat backrest but in the case of the rear facing state the seat base acts as a backrest and so it provides more comfort to a user if its length can be increased to a length similar to that of a normal seat backrest.

One of the advantages of the vehicle is that it will not restrict or prevent the rear seat being provided with the same utility as a conventional rear seat that is to say it could be configured to fold flat if so required.

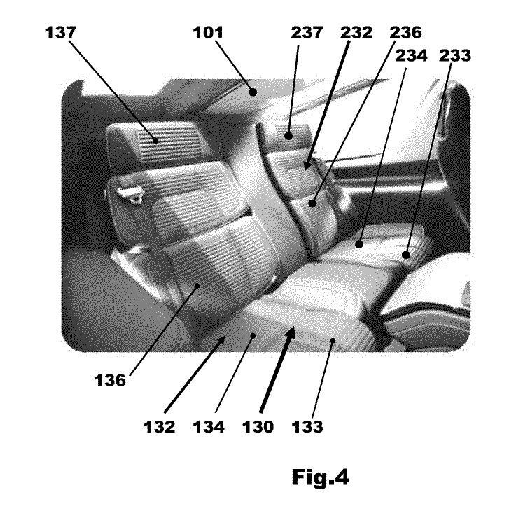

Although the vehicle has been described with respect to a third row of seats 30 comprised of a single transformable rear seat 32 it will be appreciated that it is not limited to such an arrangement and, in FIG. 4, there is shown a third row of seats 130 of a motor vehicle 101 comprised of a pair of transformable rear seats 132, 232 having the same functionality as the transformable rear seat 32 previously described. The right hand transformable rear seat 132 has a seat base 134 including an extendable seat bolster 133, a seat backrest 136 and an integral head restraint 137. The left hand transformable rear seat 232 has a seat base 234 including an extendable seat bolster 233, a seat backrest 236 and an integral head restraint 237. Each of the transformable rear seats 132, 232 is transformable between forward facing and rear facing states in the same manner as previously described that is to say, by rotation about a horizontal transverse pivot axis located near a rear end of the seat base 134, 234 when the respective seat base 134, 234 is in the forward facing state.

Furthermore, it will be appreciated that the transformable rear seat could be a second row seat if the motor vehicle only has two rows of seats. Such is often the case with hatchback type motor vehicles and small sport utility vehicles (SUVs).

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A motor vehicle comprising:
a passenger compartment;
a floor;
a number of rows of seats mounted in the passenger compartment;
a tailgate to provide access to a rear end of the passenger compartment; and
at least one seat forming a rear row of seats comprising a transformable rear seat pivotally connected at a rear end to the floor for rotation about a horizontal pivot axis arranged transversely with respect to a longitudinal axis of the motor vehicle, the transformable rear seat comprising a seat base and a seat backrest connected at one end to the rear end of the seat base, the transformable rear seat being reversibly transformable between a forward facing state and a rear facing state in which a rearmost end of the seat backrest projects beyond a rear end of the motor vehicle and the tailgate is in an open position, wherein the transformable rear seat is reversibly transformable between the forward facing state and the rear facing state by rotating the transformable rear seat about the horizontal transverse pivot axis, and wherein the seat base is slidingly supported on the floor of the motor vehicle and the transformation of the transformable rear seat from the forward facing state to the rear facing state further comprises sliding the seat base rearwardly to move the horizontal transverse pivot axis closer to the rear end of the motor vehicle.

2. The motor vehicle as claimed in claim 1, wherein, in the normal forward facing state, the transformable rear seat faces towards a front end of the motor vehicle, the seat base is substantially horizontally arranged and the seat backrest extends upwardly away from the seat base and the seat base extends forwardly away from the seat backrest and, in the rear facing state, the transformable rear seat faces towards a rear end of the motor vehicle, the seat backrest is substantially horizontally arranged and extends rearwardly from the seat base and the seat base extends upwardly away from the seat backrest.

3. The motor vehicle as claimed in claim 1, wherein the rearmost end of the seat backrest is formed by a headrest portion of the seat backrest.

4. The motor vehicle as claimed in claim 1, wherein sliding the seat base rearwardly to move the horizontal transverse pivot axis closer to the rear end of the motor vehicle increases a distance the rearmost end of the seat backrest projects beyond the rear end of the motor vehicle.

5. The motor vehicle as claimed in claim 1, wherein the seat base includes an extendable seat bolster portion and the seat bolster portion is extended in the rear facing seat state to increase a height the seat base projects upwardly from the seat backrest.

6. The motor vehicle as claimed in claim 1, wherein the seat backrest is connected at one end to the rear end of the seat base by a rake adjuster to permit an angular relationship between the seat base and the seat backrest to be adjusted.

7. The motor vehicle as claimed in claim 1, wherein the motor vehicle has three rows of seats and the transformable rear seat is a single seat forming part of the rearmost row of seats.

8. The motor vehicle as claimed in claim 1, wherein the motor vehicle has three rows of seats and the transformable rear seat is a bench seat forming the rearmost row of seats.

9. The motor vehicle as claimed in claim 1, wherein the tailgate is one of a top hinged tailgate and a side hinged tailgate.

10. A vehicle comprising:
a passenger compartment;
a floor;
a rear end;
a tailgate at the rear end; and
a transformable seat comprising a seat base and a seat backrest and pivotally connected to the floor for rotation about a horizontal pivot axis arranged transversely with respect to a longitudinal axis of the vehicle to rotate between a forward facing state and a rear facing state.

11. The vehicle as claimed in claim 10, wherein the transformable seat in the rear facing state has a rearmost end of the seat backrest that projects beyond the rear end when the tailgate is in an open position.

12. The vehicle as claimed in claim 11, wherein the seat base is slidingly supported on the floor and the transformation of the transformable rear seat from the forward facing state to the rear facing state further comprises sliding the seat base rearwardly to move the horizontal transverse pivot axis closer to the rear end of the vehicle.

13. The vehicle as claimed in claim 11, wherein, in the normal forward facing state, the transformable seat faces towards a front end of the vehicle, the seat base is substantially horizontally arranged and the seat backrest extends upwardly away from the seat base and the seat base extends forwardly away from the seat backrest and, in the rear facing state, the transformable faces towards the rear end of the vehicle, the seat backrest is substantially horizontally arranged and extends rearwardly from the seat base and the seat base extends upwardly away from the seat backrest.

14. The vehicle as claimed in claim 11, wherein the rearmost end of the seat backrest is formed by a headrest portion of the seat backrest.

15. The vehicle as claimed in claim 11, wherein sliding the seat base rearwardly to move the horizontal transverse pivot axis closer to the rear end of the vehicle increases a distance the rearmost end of the seat backrest projects beyond the rear end of the motor vehicle.

16. The vehicle as claimed in claim 10, wherein the seat base includes an extendable seat bolster portion and the seat bolster portion is extended in the rear facing seat state to increase a height the seat base projects upwardly from the seat backrest.

17. The vehicle as claimed in claim 10, wherein the seat backrest is connected at one end to a rear end of the seat base by a rake adjuster to permit an angular relationship between the seat base and the seat backrest to be adjusted.

18. The vehicle as claimed in claim 10, wherein the vehicle has three rows of seats and the transformable seat is a single seat forming part of a rearmost row of seats.

19. The vehicle as claimed in claim 10, wherein the vehicle has three rows of seats and the transformable seat is a bench seat forming a rearmost row of seats.

20. The vehicle as claimed in claim 10, wherein the tailgate is one of a top hinged tailgate and a side hinged tailgate.
